(19) United States
(12) Patent Application Publication
(10) Pub. No.: US 2014/0053685 A1
(43) Pub. Date: Feb. 27, 2014

(54) APPARATUS AND METHOD FOR TREATING CONTAINERS WITH A MECHANICAL BRAKING DEVICE

(71) Applicant: KRONES AG, Neutraubling (DE)

(72) Inventors: THOMAS HOELLRIEGL, Teublitz (DE); ANDREAS BRUNNER, Aufhausen (DE); HANS JUERGEN FLEISCHMANN, Steinberg am See (DE); JOHANNES STRAUSS, Regenstauf (DE)

(73) Assignee: KRONES AG, Neutraubling (DE)

(21) Appl. No.: 14/010,306

(22) Filed: Aug. 26, 2013

(30) Foreign Application Priority Data
Aug. 24, 2012 (DE) 10 2012 107 812.2

(51) Int. Cl. B23Q 3/00

(52) U.S. Cl. CPC B23Q 3/00
USPC 74/813 C

(57) ABSTRACT

Described is an apparatus and a method with a plurality of treatment units which are arranged on a carrier rotatable about an axis of rotation and which treat the containers in a pre-set manner, wherein the carrier is driven by at least one drive device and a speed of rotation of the carrier is retarded by at least one mechanical braking device which contacts the carrier at least for a time, and wherein for a retardation of the speed of rotation of the rotatable carrier at least one valve of the braking device is switched in a variable manner by a control device connected in terms of communication to the braking device, in such a way that a flowable medium under pressure is drawn individually from or into a reservoir of the braking device on or from a braking cylinder of the braking device.

The present invention relates to an apparatus and a method for treating containers with a plurality of treatment units arranged on a carrier rotatable about an axis of rotation according to the preambles of the present claims 1 and 8.

Apparatus for treating containers are for example blow moulding machines and stretch blow moulding machines, which have corresponding blow moulds on a rotatable carrier in order for example to expand pre-forms produced from plastics material into corresponding containers. In addition, an apparatus for treating containers can be understood as being a filling means or filling devices for filling the expanded containers by means of a suitable flowable medium, such as for example a liquid medium in the beverage production industry, in which case the corresponding filling devices are arranged at a distance from one another on the carrier. It is preferable for the individual treatment units, such as for example the blow moulds or the filling devices, to be arranged on a circular path (in a circular manner) on the carrier, such as for example a blow moulding wheel or a filling wheel, which rotates at a suitable production speed about the central axis (of rotation) thereof.

In order to drive wheels or carriers of this type, as is known from the general prior art, use is made of a servo motor which can also be used for braking the carrier. The mass of the carrier is dependent, in particular, upon the type of the machine as well as the number of the treatment units arranged on the carrier. Consequently, with a correspondingly high mass of the carrier the servo motor cannot alone completely brake the movement of the carrier in such a way that the carrier comes to a stop within a defined period of time, so that it is necessary for one or more mechanical brakes for braking the rotational speed of the carrier to be additionally arranged on the latter.

During the braking of the carrier an attempt is made to achieve a substantially linear retardation, in which case, however, the mechanical brake has an alternating torque behaviour, so that eventually these fluctuations in the torque, which can likewise result from various curves and, in particular, from the main curve on the carrier, have to be compensated by the servo motor, i.e. the main drive motor of the carrier, to which the fluctuations in the torque are transmitted, in particular in order to remain in synchronism (in the movement) at corresponding transfer points at which containers are transferred for example from a conveying device to the carrier or from the carrier to a conveying device.

The operating principle of the mechanical brake is essentially based upon reducing a movement by friction between a fixed and the moving body.

In this case the fluctuations in the torque, which are caused inter alia by the heating of the braking device or the component parts thereof respectively for example during an emergency stop for example and which can have an essentially negative effect upon the duration of the retardation of the speed of rotation of the carrier, are in part so great that they can no longer be compensated by the drive motor. The occurrence of substantial fluctuations in the torque or even fluctuations in the case, in particular, of high masses of the carriers is also due inter alia for example to the fact that the carrier with the treatment units arranged accordingly cannot be made sufficiently rigid on grounds of cost alone.

In addition, on grounds of cost the drive trains for example also have not got sufficient dimensions to handle the torques which additionally occur. As a result, the carrier consequently exhibits the behaviour of a two-mass oscillator with a low resonance frequency. This means that in a situation in which the speed of rotation of the carrier has to be stopped in a direct manner, this is only associated with a very great retardation. The torque which is required for this retardation consequently exceeds the peak torque of the drive motor by a multiple. This means that, since the available torque of the drive motor and of the mechanical brake of the carrier is connected to the carrier at the same time and completely in the event of a corresponding emergency stop situation (situation in which the speed of rotation or of rotational movement of the carrier has to be braked or retarded within a defined period of time until the complete stoppage of the rotational movement of the carrier), the behaviour of the carrier caused by the design results in pronounced oscillations, in particular between the sub-assemblies of the carrier, and this has the consequence that the peak torques which occur on the drive motor are higher by a multiple than is necessary in order to bring the mass of the carrier to a stop within a defined time.

This effect is mitigated in servo drive technology by a so-called jerk limitation, in which the acceleration/retardation and therefore the torque are increased and reduced again in a linear manner. Since the torque for the braking procedure of the carrier or of the speed of rotation of the carrier originate in particular from the mechanical brake, however, it is necessary to be able to set or regulate this torque.

Accordingly the object of the present invention is to improve the interaction of the drive motor and the mechanical brake in such a way that, in particular in an emergency stop situation, a direct influence can be exerted upon the fluctuations in the torque of the brake in such a way that the rotational movement of the carrier can be braked or retarded to a complete standstill in the shortest time, in which case, in particular, the costs of the carrier and of the drive device should be additionally reduced and consequently the components for actuating the carrier should have smaller dimensions.

This object is achieved by the present invention by means of an apparatus according to claim 1 and a method according to claim 8. Advantageous embodiments and further developments form the subject matter of the sub-claims.

Accordingly, an apparatus is claimed for treating containers with a plurality of treatment units which are arranged on a carrier rotatable about an axis of rotation and which treat the containers in a pre-set manner, with a drive device for driving the carrier and at least one mechanical braking device contacting the carrier at least for a time in order to retard the speed of rotation of the carrier.

The braking device has according to the invention at least one valve which is capable of being switched in a variable mariner by means of a control device connected in terms of communication to the braking device, in such a way that a removal or supply of a flowable medium under pressure from or to a reservoir of the braking device is capable of being carried out individually on or by a braking cylinder of the braking device in order to achieve a braking effect.

This means that it is preferable for the braking force to be advantageously reduced in the event of an increase in the torque and increased in the event of a drop in the torque by means of a regulated brake or braking device or a brake or braking device which is capable of being regulated respectively, in order consequently to minimize or compensate the fluctuations in the torque substantially by way of the brake or the braking device respectively.

Consequently the brake or the braking device respectively is in contact at least for a time and preferably permanently with the carrier in order to adapt the braking power of the braking device to the speed of rotation of the carrier and the deflections of the oscillations or vibrations or fluctuations respectively. Although the driving power could possibly also be increased for example as a result, fluctuations in the drive are nevertheless additionally reduced to an adequate degree and consequently a substantially steadier running of the drive machine is achieved.

It is preferable for any brakes known from the general prior art to be used for this.

In this case the valve is preferably a pneumatic valve or a valve acting or operating by means of a pneumatic medium or even advantageously an hydraulic valve or a valve acting or operating by means of an hydraulic medium.

Consequently it is preferable for a pneumatic medium or a pneumatic means to be a gaseous medium, such as for example compressed air, whilst an hydraulic medium or an hydraulic means is a liquid medium, such as for example water, oil, etc.

The corresponding reservoir of the braking device can accordingly be a pneumatic reservoir for receiving a pneumatic flowable medium (air reservoir) or an hydraulic reservoir for receiving an hydraulic flowable medium (oil reservoir).

Since, as is known, influence can no longer be exerted upon the extreme fluctuations in the torque of this brake in the case of known mechanical brakes and, in particular, in the case of known air brakes which develop a braking effect in the aerated state for example, according to the invention at least one pneumatic or hydraulic valve or even two or more valves is or are arranged in the braking device, and are consequently controlled or regulated respectively in such a way that this valve for example lets a defined amount—capable of being controlled or regulated respectively—of a flowable medium under pressure into the braking cylinder or lets it out of the brake cylinder in order to achieve a braking effect.

The present invention is described here with reference to brakes or braking devices operating pneumatically, in which case, however, it is pointed out that the invention is also capable of being applied to brakes or braking devices operating hydraulically.

The mechanical brakes known from the general prior art, such as for example the air brake, are advantageously aerated with the aid of compressed air by way of a suitable valve during the operation of the carrier and the treatment units thereof, i.e. consequently during the treatment of the containers, the brake being aerated by way of this valve in the event of a necessary stop or stoppage (for example in the event of an emergency stop situation), so that the brake consequently performs its braking effect.

In this case it is possible for a brake cylinder to be acted upon with compressed air in order to achieve a braking effect or for compressed air to be removed from the brake cylinder in order to achieve a braking effect.

Accordingly, an operating pressure necessary for actuating the brake is preferably controlled and optionally regulated by a variable switching of the valve. It is preferable therefore for the brake or braking device respectively to be controlled and regulated.

As already mentioned above, the rotatable carrier, which rotates about a central axis of rotation at a defined speed during the treatment of the containers, can be for example a blow moulding wheel or even a filling wheel. Accordingly, the containers can be expanded by expansion for example from a plastics material pre-form into a plastics material container with the aid of a blow mould or a blow moulding station (the carrier is a blow moulding wheel) or can also be filled with a suitable flowable medium during the treatment (the carrier is a filling wheel). It is advantageous for the apparatus to be a blow moulding machine, preferably a so-called stretch blow moulding machine. It is also possible, however, for the apparatus to be a closure machine for closing the containers, a sterilization machine for sterilizing the internal and/or external walls of the containers or a labelling machine for labelling the containers etc.

Consequently the pressure at which the brakes or braking devices respectively are aerated or vented preferably acts as a setting variable of the adjustment or regulation of the pneumatic or hydraulic valves. In this case the pressure is approximately linear with respect to the braking force. The drag error (nominal/actual position) of the motor regulation (determined by way of the control device) can act as a control deviation. This means that the torque of the brake or the braking device respectively is too low, the motor position will run ahead of the nominal position and the drag error will become negative. If, on the other hand, the torque of the braking device is too great, the motor position will run behind the nominal position and the drag error will become positive. A regulating circuit for regulating the braking force is consequently set up whilst taking into consideration the drag errors which have occurred' or which are capable of occurring, in order to be able to regulate deviations—which occur—(actual) from the braking force to be expected (nominal).

It would also be possible to use the deviation between the nominal motor current and the actual motor current as a regulating deviation. In this case it is possible—by means of modelling an ideal load with a certain mass inertia and friction—to predict how great the motor current ought to be during a braking procedure (for example in the event of an emergency stop). If the value of the actual motor current deviates from the value of the nominal motor current, this is advantageously compensated by regulation of the braking force.

The aforesaid drive device is preferably an electric motor which is used both for accelerating and for retarding the carrier. In particular, it is preferably possible for a so-called torque motor or slow runner to be provided, which has a high pole number and at least one annular grooved rotor with a large diameter. Typical ranges of the speed of rotation of torque motors of this type are between 1 r.p.m. and approximately 1,200 r.p.m., in which case in particular high torques of up to 4,000 Nm and thus a direct connection (without an intermediate gear mechanism), as on the aforesaid carrier, consequently become possible with torque motors of this type.

In particular, the drive device has a driven wheel designed to be rotationally fixed to the carrier for rotating the carrier as well as a corresponding drive motor. It is preferable for the treatment units to be moved by the carrier on a circular path, so that the containers to be treated accordingly with the treatment units are also moved on this circular path during their treatment. In a preferred embodiment the drive device has a drive wheel arranged with the drive motor on a driven shaft of the drive motor for example, and this drive wheel co-operates directly with the driven wheel in order to rotate the carrier. In this case it is possible for the rotationally fixed connection between the carrier and the driven wheel to be designed in such a way that the carrier is rotatable by way of a drive shaft and the driven wheel is arranged in turn on this drive shaft.

In the case of a further advantageous embodiment, however, this driven wheel is formed directly with the carrier or is arranged directly on the carrier respectively, so that for example the carrier itself has an external set of teeth or has a driven wheel with a corresponding external set of teeth in which the drive wheel engages. A direct co-operation is to be understood as being that no further driven wheels are arranged between the drive wheel and the driven wheel and also no belt or other power-transmission means is or are provided.

It is advantageous for the treatment units arranged on the rotatable carrier to have a supply means which supplies a flowable medium to the containers. In the case of a blow moulding wheel as the carrier or the carrier wheel it may be for example a gaseous medium such as compressed air which is used for the expansion of the containers. In the case of a filling wheel as the carrier or the carrier wheel it may also be, on the other hand, a liquid medium such as for example the beverage product with which the containers are to be filled. In the case of a sterilization device or machine as the carrier or the carrier wheel a corresponding sterilization medium (liquid or gaseous) can also, on the other hand, be conveyed by way of the supply means in the direction of the containers to be treated.

In addition, it is advantageous for each treatment unit also to have at least one movable element which is movable in a direction at a right angle at least also to a movement direction of the containers. This movable element can be for example a blow moulding nozzle, an element which applies closures to the containers, a stretch bar or even a filling device for a beverage.

In the case of a further advantageous embodiment each treatment unit has a gripping element which grips the containers in a specific region of the containers, such as for example the neck region of the containers and, in particular, below a carrier ring or a securing ring of the containers. These gripping elements may be for example gripping clamps which grip the containers in particular on or below the carrier ring of the containers.

The braking device is preferably arranged, like the drive device, in a region on the external periphery of the carrier, in order—where necessary or in the event of the braking device being triggered—to contact a region and in particular an external region of the carrier at least for a time in such a way that the speed of rotation of the carrier is retarded or braked, preferably to a stop, on account of the holding force occurring between the braking device and the carrier. Depending upon the mass of the carrier and depending upon the current speed of rotation during the treatment of the individual containers by means of the corresponding treatment elements, the brake has to exert a defined braking effect upon the carrier in order to be able to brake the latter to a standstill.

Accordingly, a control device, which is preferably also used for controlling the drive device for driving the carrier, is consequently connected to the braking device in such a way that when a braking procedure is initiated, for example on account of an emergency stop, the control device can control the pneumatic or hydraulic valve in such a way that a corresponding operating pressure is made available in a manner dependent upon the speed of rotation of the carrier currently determined by the control device and also the initiated braking force of the drive device which can likewise act as an additional braking device.

This means that the control device determines essential facts of the carrier, such as the mass or the speed of rotation of the carrier, and also of the drive device, such as for example the retardation power etc., and accordingly actuates the pneumatic or hydraulic valve of the mechanical braking device, so that consequently the valve automatically lets in a pre-defined quantity of flowable medium (compressed air) under pressure or acted upon with pressure respectively from the brake cylinder or into the brake cylinder respectively in order to exert a defined braking effect upon the carrier.

It is consequently advantageous for there to be between the braking device and the control device a bidirectional communication connection, by way of which the control device receives values with respect to the braking device, such as for example the operating pressure currently present, on the one hand, and sends commands to the braking device and in particular the pneumatic or hydraulic valve for setting the pneumatic or hydraulic valve with respect to the quantity of compressed air or hydraulic medium to be let through on the other hand. A corresponding bidirectional connection is also preferably present between the control device and the drive device. This means that the control device consequently receives data with respect to the currently existing torque of the drive device in order also to be able to transmit data with respect to a corresponding (necessary) retardation moment when a retardation procedure of this drive device is initiated.

In a preferred embodiment the pneumatic or hydraulic valve is a proportional valve or a proportional directional-control valve which permits a steady transition of the valve opening whilst using a proportional magnet. As a result, the medium of the compressed air (or also the hydraulic medium) for example can be varied with the aid of the proportional valve in order to actuate the braking effect in a manner dependent upon the electronic input variable. The proportional valve consequently regulates the outlet pressure in a closed regulating circuit in a manner proportional to the pre-set nominal value signal, so that the outlet pressure is consequently constantly compared with a desired nominal value and is permanently regulated.

As a result, the defined or desired nominal value is pre-set on the proportional valve by way of the control device whilst taking into consideration a desired linear retardation of the speed of rotation of the carrier and the outlet pressure is adapted accordingly by the proportional valve itself whilst taking into consideration the fluctuations occurring in the torque, for example triggered by the braking effect of the drive device or even by a braking effect of the braking device itself, so that consequently the braking effect acting upon the carrier can be set individually whilst taking into consideration the aforesaid factors. This means that for example at the beginning of the initiated retardation a greater or even lesser braking effect is applied to the carrier than for example during the retardation procedure when the speed of rotation of the carrier is approximately zero.

In the case of a further advantageous embodiment the braking device has at least two or more valves and, in particular pneumatic or hydraulic valves, which can be switched in a manner independently of each other by means of the known control device. In addition, it is possible in this case for the at least two valves to have a mutually different pressure level, so that the braking cylinder is fed with a first operating pressure or a defined first quantity of compressed air or hydraulic medium respectively by means of the first valve during a first braking time period and accordingly with a second operating pressure or a defined second quantity of compressed air or hydraulic medium respectively by means of the second valve during a second braking time period which follows on from the first braking time period, and this compressed air or the operating pressure or the hydraulic medium under pressure respectively is removed from the braking cylinder.

In addition, it is also possible in this case for the second braking time period using the second valve to be followed by a third braking time period using the first valve again etc. By using valves capable of being switched in this way inside a braking apparatus it is possible for fluctuations in the torque acting upon the carrier during the retardation procedure to be advantageously compensated in order to be able to implement a retardation—which is substantially linear at least for a time—of the speed of rotation of the carrier.

In this case it is possible for the braking device to have not a proportional valve, [but?] preferably a proportional valve and in a particularly preferred manner two and more proportional valves, in which case each pneumatic or hydraulic valve arranged in a braking device can also be a proportional valve.

It is also possible for a plurality of braking devices to be arranged at a distance from one another on an external periphery of the carrier. This means that for example two or three or more braking devices are arranged substantially distributed, i.e. at an equal distance from one another and preferably also from the drive device, on the external periphery of the carrier, in order to retard or brake the speed of rotation of the carrier preferably to a standstill during the initiation of a retardation procedure. In this case the individual braking devices can have for example in each case at least one proportional valve and/or also valves of widely differing design. It is preferable for each braking device to have a communication connection with the control device, so that in a preferred embodiment the braking devices and, in particular, the valves of the braking devices are capable of being switched alternately and independently of one another by means of the control device.

It is preferable for the braking device to have at least one, in particular pre-stressed, spring element for exerting a braking force, in which case the braking force is exerted in particular upon a corresponding brake block of the braking device which interacts with a brake disc or even with a brake drum. This means that the braking force from the brake block interacts with a brake disc which extends for example at least in part in the peripheral direction of the carrier and is arranged substantially on the external periphery of the carrier. In this embodiment the braking device, and in particular the brake block or the brake pad of the brake block of the braking device respectively, contacts at least an area, and in particular the external periphery of the carrier, in particular only during the braking procedure (for a time), in order consequently to reduce or brake the speed of rotation by the application of a frictional force.

It is also possible, however, for the braking apparatus also to be in contact with the carrier during the treatment procedure of the containers and consequently to have a speed of rotation—adapted to the speed of rotation of the carrier—about its own axis of rotation. In this case, during the braking or retardation procedure a contacting would take place between the brake block or the brake pad of the brake block of the braking device respectively and, in particular, a brake drum or even a brake disc, which likewise represents a component part of the braking device, in order to reduce the speed of rotation of the braking device and, as a result, consequently also the speed of rotation of the carrier operatively connected to the braking device.

In particular, the spring element in the braking device is arranged in the region of the braking cylinder and is pre-stressed in such a way that in the event for example of aeration or even of venting of the braking cylinder or the pressure chamber of the braking cylinder a movement of the brake block, which can additionally have brake pads, can be triggered in the direction of the brake disc or also a brake drum, in order to obtain a contacting between the brake block and the brake disc or the brake drum respectively.

It is advantageous for the drive device of the carrier to be a direct drive for driving the carrier, the direct drive being characterized—with respect to known conventional drives—in that it does without gear mechanisms and components susceptible to wear. In this way, losses due to friction in the system can be prevented and consequently the energy balance can be increased in a positive manner. In addition, the overall efficiency is increased and the power supplied is used more efficiently. Furthermore, consequential costs can be prevented by the use of direct drives. A further advantage is that direct drives run virtually silently and the operation thereof consequently has a noise-reducing effect. In addition, as compared with conventional drives, the direct drive has a compact structural shape with a small space requirement. Since the direct drive, in particular, also does without an interposed pinion, this direct drive should accordingly be described as requiring little maintenance.

It is advantageous, as already stated above, for the drive device to engage on an external periphery of the carrier, in which case a drive wheel driven directly or indirectly by way of a drive motor engages in a driven wheel arranged on the carrier or even a component part of the carrier and transmits the speed of rotation thereof accordingly.

Furthermore, a method is claimed for treating containers with a plurality of treatment units which are arranged on a carrier rotatable about an axis of rotation and which treat the containers in a pre-set manner, in which case the carrier is driven by means of at least one drive device and the speed of rotation of the carrier is retarded by means of at least one mechanical braking device which contacts the carrier at least for a time.

According to the invention, for a retardation of the speed of rotation of the rotatable carrier a valve of the braking device is switched in a variable manner by a control device connected in terms of communication to the braking device, in such a way that a flowable medium under pressure, such as for example an hydraulic or pneumatic medium, is drawn individually from or into a reservoir of the braking device on or from a braking cylinder of the braking device, i.e. whilst taking into consideration the currently prevailing circumstances, such as the current speed of rotation of the carrier, the mass thereof etc.

Consequently it is possible for the valve capable of being switched in a variable manner to be a pneumatic or hydraulic valve.

This means that a moment, by means of which the carrier has to be braked when a retardation of the speed of rotation of the carrier is initiated, is determined preferably in a manner dependent upon the present mass of the carrier and the currently determined speed of rotation of the carrier etc. during the treatment of the containers, in order to come to a standstill within a defined period of time and/or within a defined path of movement. After a corresponding nominal value (moment of the retardation) has been determined, the at least one valve of the braking device is switched or opened or closed respectively in such a way that in each case (per switching procedure) for example a defined flow of compressed air or operating compressed air or a defined quantity of hydraulic medium can flow into a brake cylinder or a compressed air chamber or medium chamber of the brake cylinder or out of the latter, in order to exert a defined braking effect of the brake block connected to the brake cylinder upon a corresponding brake disc or a corresponding brake drum respectively.

In a preferred embodiment it is possible—as already mentioned above—for a plurality of braking devices, such as for example two, three or more, to be arranged at a distance from one another in the peripheral direction around the carrier, each braking device having a separate pneumatic or hydraulic valve, so that these valves of a plurality of braking devices contacting the carrier can be switched alternately and independently of one another by the control device. This means that the valve or the valves of a braking device or the valves of the plurality of braking devices is or are activated simultaneously or staggered in time with respect to one another depending upon requirements, in which case each braking device can exert a defined braking effect upon the carrier. The braking effects of the individual braking devices can be different from one another in this case and they are ascertained, in particular, from the values of the mass of the carrier which are determined by the control device, from the currently prevailing speed of rotation of the carrier and/or the determined oscillations or fluctuations in the torque of the carrier.

This means that, when a retardation of the speed of rotation of the carrier is initiated, quantities—of different size—of flowable medium, preferably under pressure, such as for example compressed air, can be supplied to or removed from individual brake cylinders of the braking devices by way of the valves of the braking devices.

It is also possible in this case, however, for only one mechanical brake or braking device to be used for the retardation of the speed of rotation of the carrier, in which case this braking device has for example two or more pneumatic or hydraulic valves which can be switched independently of each other and can also have or set a pressure level different from each other.

In addition, the braking device can also advantageously have only, in particular, a single pneumatic or hydraulic proportional valve or even two or more proportional valves which is or are switched proportionally to the stressed pressure.

In particular, the drive device itself acts at least for a time as an additional braking device during the retardation of the speed of rotation of the carrier. This means that when a retardation procedure of the speed of rotation of the carrier is initiated, not only is the mechanical braking device itself actuated by the control device, but the drive device also receives from the control device the command to reduce its speed of rotation in accordance with defined guidelines, so that the drive motor of the drive device consequently implements or causes a motor brake.

It is preferable for the speed of rotation of the carrier to be retarded completely within a rotational movement of a maximum of 270° of the carrier about the axis of rotation thereof. This means that, within a rotational movement of a maximum of 270° from a starting point determined from the initiation of the retardation procedure, the carrier and in particular the rotational movement or speed of rotation of the carrier is braked completely to a standstill.

On account of a defined regulation or control of the braking device it is also possible for the braking device to be capable of being over-dimensioned, as a result of which it is possible to compensate advantageously existing occurrences of wear on the braking device or individual (component) parts of the braking device by adaptation of the brake actuation means.

In particular, the apparatus according to the invention is a component part of a plant for treating containers, which in addition has a first conveying device arranged around a pre-set axis of rotation for supplying the containers to be treated to the apparatus and a second conveying device arranged around a pre-set axis of rotation for removing the treated containers from the apparatus. In particular, in addition to the apparatus according to the invention the first and the second conveying devices also have in each case a separate drive device for driving the first and the second conveying devices respectively, so that consequently at least three drive devices, which in particular constitute direct drives, are arranged in the plant.

In a further preferred embodiment the drive devices, i.e. the drive devices of the first conveying device, the drive device of the first conveying device and the drive device of the apparatus according to the invention, are connected in each case in terms of communication with the control device, which can also be referred to as the central control device. In particular, the respective drive devices as well as also the aforesaid braking device of the control device are synchronized with one another in such a way that during a treatment of the containers the supplying conveying device, the apparatus according to the invention and the removing conveying device essentially have speeds of rotation identical with one another or adapted to one another, in order to ensure a problem-free transfer of the containers from the supplying conveying device to the apparatus according to the invention and from the apparatus according to the invention to the filling conveying device.

This means that a synchronous running of the individual drive devices or servo motors respectively with respect to one another can be produced by means of the control device. In addition, a reduction of the torque of the respective drive devices of the supplying conveying device, the removing conveying device and the apparatus according to the invention should also be made possible in the case of initiating a retardation procedure of the speed of rotation of the carrier. Accordingly, the control device is connected to the individual drive devices and the braking device or the individual braking devices respectively in such a way that during a retardation procedure a continuous and mutually independent braking effect can be achieved by the braking device and the individual drive devices, since these can be activated and deactivated respectively independently and in a manner staggered in time for example.

In this way, it is also possible for example for the supplying conveying device and/or the removing conveying device also to have in each case at least one braking device which contacts these conveying devices, so that, in addition to the apparatus according to the invention, the supplying conveying device and/or the removing conveying device can also be braked not only by way of a created brake of the drive motor of the drive device but also by way of an additional mechanical brake.

Further advantages, aims and properties of the present invention are explained with reference to the following description of the accompanying drawing, in which inter alia an arrangement of the braking devices with reference to the carrier or a switching diagram of the braking device is illustrated by way of example.

Components which correspond at least substantially in their function in the figures can be designated in this case with the same reference numbers, in which case it is not necessary for these components to be designated and explained in all the figures.

In the figures

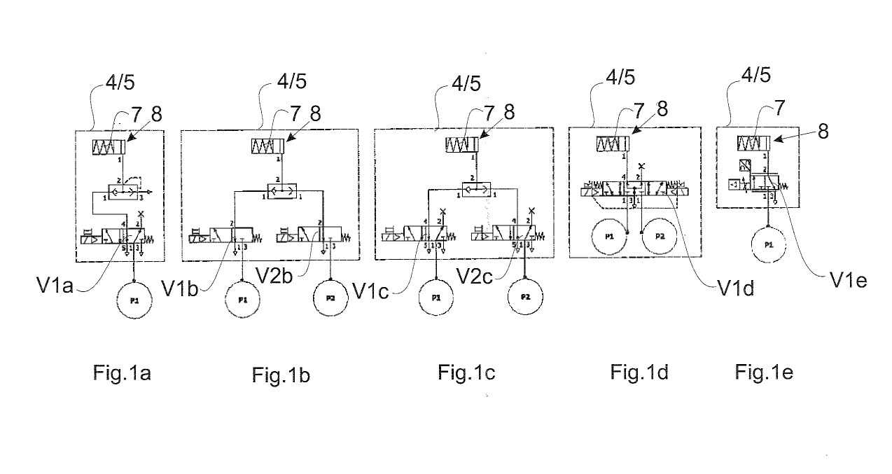

FIG. 1a is a switching diagram of a braking device 4, 5 in a first embodiment known from the general prior art with a first valve V1a which is a 5/2-way valve;

FIG. 1b is a switching diagram of a braking device 4, 5 of the apparatus according to the invention in a second embodiment with a first valve V1b and a second valve V2b which are in each case two 3/2-way valves;

FIG. 1c is a switching diagram of a braking device 4, 5 of the apparatus according to the invention in a third embodiment with a first valve V1c and a second valve V2c which are in each case two 5/2-way valves;

FIG. 1d is a switching diagram of a braking device 4, 5 of the apparatus according to the invention in a fourth embodiment with a first valve V1d which is a 5/3-way valve;

FIG. 1e is a switching diagram of a braking device 4, 5 of the apparatus according to the invention in a fifth embodiment with a valve V1e which is a proportional valve;

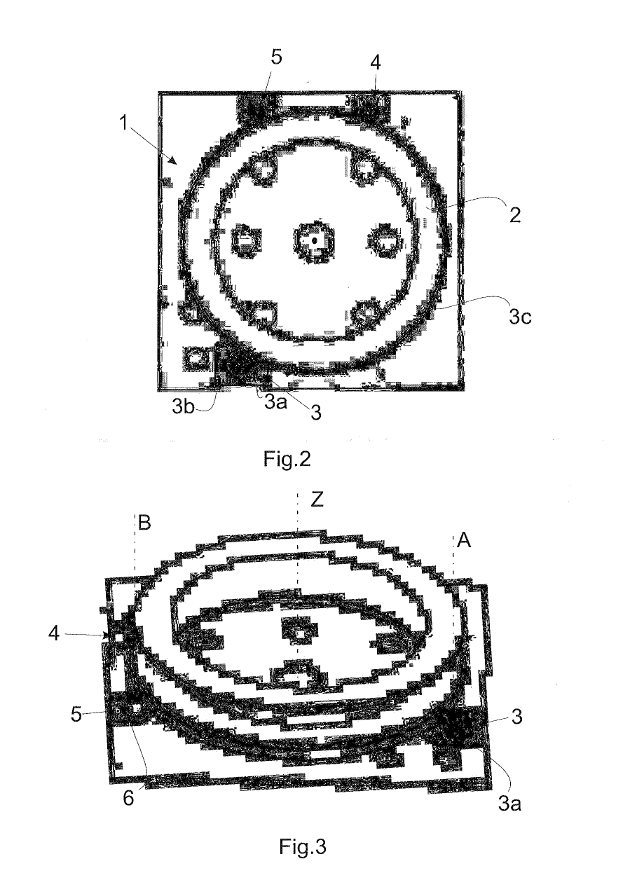

FIG. 2 is a plan view of a diagrammatic outline view of an embodiment of the apparatus 1 according to the invention with a drive device 3 as well as two braking devices 4, 5, and

FIG. 3 is a three-dimensional view of a diagrammatic outline view of the embodiment shown in FIG. 2.

FIG. 1a shows a switching diagram of a compressed air brake or braking device 4, 5 known from the general prior art with a first valve V1a, which in particular is a 5/2-way valve, in which the valve V1a completely vents the brake by way of a rapid venting valve when a braking procedure is initiated, in which case a braking force is effected by an expansion of the at least one spring element 7 which acts upon a brake disc (not shown here) or a brake drum (not shown here) respectively in order to apply a braking force from a brake block (not shown here).

As is known, the first number of a directional valve refers to the number of connections, whilst the second number refers to the number of switching positions.

The valve V1a shown in FIG. 1a is not capable of being regulated, so that consequently the compressed air P1 introduced into or also let out of the pressure cylinder 8 or the brake cylinder 8 respectively by the valve V1a cannot be adapted in accordance with defined requirements and whilst taking into consideration currently existing conditions, such as the speed of rotation of the carrier. In fact from the moment of the beginning of the initiation of the braking procedure the control pressure is vented completely or entirely or is entirely aerated again in order to release the brake.

FIG. 1b indicates a switching diagram of a second embodiment of a braking device 4, 5 for braking the speed of rotation of the carrier, which can be used in the apparatus according to the invention in order to implement a linear course of the retardation of the speed of rotation at least for a time. The valve V1a shown in FIG. 1a has been replaced in this case by two valves V1b and V2b and, in particular, two 3/2-way valves which are acted upon in each case with different pressures P1 and P2 respectively and consequently set another pressure level in each case. This means that the valve V1b allows a quantity—different from the valve V2b for example—of operating pressure P1 (pneumatic medium, such as compressed air or hydraulic medium) to pass in the direction of a corresponding reservoir. Accordingly, the two valves V1b and V2b can consequently be switched for example by means of a control device (not shown here) in an alternating manner, i.e. staggered in time with respect to each other, so that the brake 4, 5 or the braking device 4, 5 respectively can consequently supply different braking moments or braking forces respectively. This means that for example the first valve V1b allows a flow of air (when a pneumatic valve is present) or a flow of liquid (when an hydraulic valve is present) at a pressure P1, which for example is in a range up to 10 bar, preferably from 1 to 10 bar and in a particularly preferred manner from 5 to 8 bar, to pass into the brake cylinder 8 or out of the brake cylinder 8, as a result of which a complete braking could consequently be made possible. In order to compensate fluctuations in the torque arising accordingly as a result, however, the second valve V2b permits a lower pressure level. This means that this second valve V2b for example allows only one flow of air (when a pneumatic valve is present) or one flow of liquid (when an hydraulic valve is present) at a pressure P2, which is preferably lower than the pressure P1, to flow into the brake cylinder or out of the brake cylinder 8, in order to achieve in this way only a partial aeration or venting of the brake cylinder 8 and thus a reduced braking effect. By means of a corresponding alternate switching between the first valve V1b and the second valve V2b an alternating braking effect or braking power between an accordingly high braking effect and a lower braking effect as compared with the latter is consequently achieved. By means of valves V1b, V2b consequently capable of being controlled in this way, fluctuations in the torque which act upon the carrier are compensated.

The application of a pressure level different in this way by means of two valves which are capable of being switched independently of each other and differently from each other in time at least in part is also shown for example by the switching diagram of FIG. 1c, in which a braking device 4, 5 is shown in a third embodiment with two 5/2-way valves V1c and V2c instead of the 3/2-way valves V1b and V2b shown in FIG. 1b.

FIG. 1d shows a fourth embodiment of the braking device 4, 5 of the apparatus according to the invention, in which only a single valve V1d is used, as known from the prior art and as indicated by way of example in FIG. 1a, in which case the 5/3-way valve V1d shown here can set two pressure levels in the brake cylinder 8 by means of two pressures P1 and P2 which are different from each other. This means that the single valve V1d can be actuated by means of a control device (not shown here) in such a way that this valve at one time allows a flow of air (when a pneumatic valve is present) or a flow of liquid (when an hydraulic valve is present) at a pressure P1 to flow into the brake cylinder 8 or out of the brake cylinder 8 and at another time allows a flow of air (when a pneumatic valve is present) or a flow of liquid (when an hydraulic valve is present) at a substantially lower pressure P2, as a result of which a different braking effect can also consequently be exerted upon the carrier on account of the pressure level capable of being set differently in the brake cylinder 8.

The switching diagram of a fifth embodiment of the braking device 4, 5 of the apparatus according to the invention shown in FIG. 1e has substantially only one so-called proportional valve V1e which implements the pressure level in the brake cylinder in accordance with an electrical signal acting upon the valve V1e, so that the pressure is controlled in a manner proportional to the signal from the valve V1e. This means that in this case the braking effect compensating the fluctuation in the torque is made possible by way of a pressure level regulation of the proportional valve.

It is advantageous for the operating pressure required for actuating the brake to be controlled and, in particular, regulated by means of the embodiments of the braking device 4, 5 and, in particular, the valves V1b to V1e thereof presented in FIGS. 1b to 1e.

FIG. 2 shows a plan view of a diagrammatic illustration of an embodiment of the apparatus 1 according to the invention, in which the apparatus 1 has a carrier 2 which is mounted so as to be rotatable about a central axis of rotation Z and which is driven by a drive device 3 in such a way that the carrier 2 has a defined speed of rotation about its axis of rotation Z during a treatment of containers, such as for example a stretch blow moulding of pre-forms to form containers or a filling of containers with a suitable medium.

In addition, two braking devices 4 and 5, which are arranged at a distance from each other and which—like a drive device 3 as well—are arranged on the external periphery of the carrier 2, are shown in FIG. 2. It would also be possible, however, for the drive device 3 and/or at least one of the braking devices 4 or 5 to be fitted in the carrier itself or to be arranged on the carrier itself and consequently to move jointly with the carrier about the axis of rotation thereof. This means that the drive device 3 and/or at least one of the braking devices 4 or 5 either is or are arranged stationary and fixed (immovable) with respect to the carrier or is or are arranged on the latter.

According to FIG. 2, the braking devices 4 and 5 of the drive device 3 are arranged in a substantially opposed manner on the carrier, in which case the braking devices 4 and 5 could also be arranged on the carrier 2 laterally as viewed with respect to the drive device 3 or also on the same side of the drive device 3. The drive device 3 has in particular a drive wheel 3a which is driven by means of a drive motor 3b. The drive wheel 3a corresponds structurally to the design of a gearwheel and engages in particular in a driven wheel 3c which is illustrated only diagrammatically here and which is like-wise preferably toothed or has a defined surface structure and extends preferably completely around the carrier 2 in the peripheral direction on the external periphery, so that the driven wheel 3c (positively locking and/or non-positively locking force or movement transmission) and consequently the carrier 2 itself [are] also set in a rotational movement about the axis of rotation Z thereof by the rotational movement of the drive wheel 3a.

In FIG. 3 the embodiment of the apparatus 1 according to the invention shown in FIG. 2 is illustrated in a three-dimensional view of a diagrammatic outline illustration, from which it is clearly evident that, in particular, the axis of rotation A of the drive device 3, the axis of rotation Z of the carrier 2 and also the axes of rotation B of the braking devices 4 and 5 extend parallel to one another. The drive device 3 and the braking devices 4 and 5 are advantageously arranged in each case in a lower region of the carrier, in which case the drive device 3 contacts or engages substantially permanently in a suitably arranged driven wheel 3c by means of a corresponding drive wheel 3a and consequently permanently contacts the carrier 2 substantially at least indirectly.

A direct contact between the drive wheel 3b and the carrier 2 preferably takes place when the driven wheel 3c is a component part of the carrier 2 itself and, in a particularly preferred manner, when at least one region of the external periphery of the carrier 2 is designed in the form of a driven wheel 3c in order to act with the drive wheel 3b. In addition, the braking devices 4 and 5 can be arranged in such a way that they are essentially in constant contact with the external periphery and, in particular, the driven wheel 3c of the carrier 2, in which case, during a production procedure and thus during the treatment of containers in which the carrier 2 rotates about the axis of rotation Z thereof at a defined speed of rotation, the braking devices 4 and 5 are also rotated about the corresponding axis of rotation B thereof at a defined speed of rotation. In this case a retardation of the rotational movement or the speed of rotation respectively of the carrier 2 would take place as a result of a reduction of the rotational movement or the speed of rotation respectively of the braking devices 4 and 5 and/or the drive device 3.

If a braking procedure of the carrier 2 is initiated, brake blocks (not shown here) are consequently brought into contact with corresponding brake discs or brake drums 6 respectively, as a result of which a retardation of the speed of rotation of the braking devices and thus of the carrier 2—which is in operative contact with the two braking devices 4 and 5—takes place as a result of the friction between the brake block and the brake drum 6. In this case the braking devices 4 and 5 can be designed [with] two valves, as shown in FIGS. 1b, 1c, 1d, or with a proportional valve as shown in FIG. 1e.

In addition, it would be possible for the braking devices 4 and 5 not to be in contact with the carrier 2 and, in particular, the external periphery of the carrier 2 during the treatment procedure of the containers and thus during a substantially continuous speed of rotation of the carrier 2 about the axis of rotation Z thereof. This means that in this case only the carrier 2 and the corresponding drive device 3 or the drive motor 3b and drive wheel 3a thereof would rotate in each case about the axes of rotation A and Z respectively thereof at a speed of rotation defined in each case.

In this way, during the initiation of a retardation procedure of the speed of rotation of the carrier 2 a contacting would consequently have to take place between the individual braking devices 4 and 5 and the carrier 2 or the outer wall thereof respectively and in particular of the driven wheel 3c. A corresponding partial contacting between the braking devices 4 and 5 and the carrier 2 only during a braking procedure could also be implemented by the respective braking devices 4 and 5 having only brake blocks which when the brake cylinder is released move in the direction of the carrier 2, which accordingly has a brake disc which can be brought into contact with the brake blocks in order to achieve a braking effect.

The Applicants reserve the right to claim all the features disclosed in the application documents as being essential to the invention, insofar as they are novel either individually or in combination as compared with the prior art.

### LIST OF REFERENCES

1 apparatus

2 carrier

3 drive device

3a drive wheel

3b drive motor

3c driven wheel

4, 5 braking device

6 brake drum

7 spring element

8 brake cylinder

A axis of rotation of the drive device

B axes of rotation of the braking device

Z axis of rotation of the carrier

P1 and P2 pressure

V1a, V1c first 5/2-way valve

V1b first 3/2-way valve

V1d first 5/3-way valve

V1e proportional valve

V2b second 3/2-way valve

V2c second 5/2-way valve

1. An apparatus for treating of containers with a plurality of treatment units which are arranged on a carrier rotatable about an axis of rotation and which treat the containers in a pre-set manner, with a drive device for driving the carrier and at least one mechanical braking device contacting the carrier at least for a time in order to retard the speed of rotation of the carrier, characterized in that the braking device has at least one valve (V1b, V2b, V1c, V2c, V1d, V1e) which is capable of being switched in a variable manner by a control device connected in terms of communication to the braking device, in such a way that a removal or supply of a flowable medium (P1, P2) under pressure from or to a reservoir of the braking device is capable of being carried out individually on or by a braking cylinder of the braking device in order to achieve a braking effect.

2. The apparatus according to claim 1, wherein the valve (V1b, V2b, V1c, V2c, V1d, V1e) is a pneumatic valve or an hydraulic valve.

3. The apparatus according to claim 1, wherein the valve (V1b, V2b, V1c, V2c, V1d) is a proportional valve (V1e).

4. The apparatus according to claim 1, wherein a plurality of braking devices are arranged at a distance from one another on an external periphery of the carrier.

5. The apparatus according to claim 1, wherein the valves (V1b, V2b, V1c, V2c, V1d, V1e) of the braking device or of a plurality of braking devices respectively are capable of being switched alternately and independently of one another.

6. The apparatus according to claim 1, wherein the braking device has at least one pre-stressed spring element for exerting a braking force.

7. The apparatus according to claim 1, wherein the drive device is a direct drive for driving the carrier.

8. The apparatus according to claim 1, wherein the drive device engages on an external periphery of the carrier.

9. A method for treating containers with a plurality of treatment units which are arranged on a carrier rotatable about an axis of rotation and which treat the containers in a pre-set manner, wherein the carrier is driven by at least one drive device and a speed of rotation of the carrier is retarded by at least one mechanical braking device which contacts the carrier at least for a time, wherein for a retardation of the speed of rotation of the rotatable carrier at least one valve (V1b, V2b, V1c, V2c, V1d, V1e) of the braking device is switched in a variable manner by a control device connected in terms of communication to the braking device, in such a way that a flowable medium (P1, P2) under pressure is drawn individually from or into a reservoir of the braking device on or from a braking cylinder of the braking device.

10. The method according to claim 9, wherein the valves (V1b, V2b, V1c, V2c, V1d, V1e) of one or more braking devices contacting the carrier are switched preferably alternately and independently of one another by the control device.

11. The method according to claim 9, wherein, when a retardation of the speed of rotation of the carrier is initiated, quantities—of different size—of flowable medium are supplied to or removed from individual brake cylinders of the braking devices by way of the valves (V1b, V2b, V1c, V2c, V1d, V1e) of the braking devices.

12. The method according to claim 9, wherein the valve (V1b, V2b, V1c, V2c, V1d) is a pneumatic or hydraulic proportional valve (V1e) which is switched proportionally to the stressed pressure (P1, P2).

13. The method according to claim 9, wherein the drive device acts at least for a time as an additional braking device during the retardation of the speed of rotation of the carrier.

14. The method according to claim 9, wherein, wherein the speed of rotation of the carrier is retarded completely within a rotational movement of a maximum of 270 degrees of the carrier about the axis of rotation thereof.
